(19) United States
(12) Patent Application Publication
(10) Pub. No.: US 2005/0128219 A1
(43) Pub. Date: Jun. 16, 2005

(54) Display enhancement apparatus and method

(76) Inventor: Charles Stephen Beal, San Juan Capistrano, CA (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/732,828

(22) Filed: Dec. 11, 2003

(51) Int. Cl. G06T 11/00

(52) U.S. Cl. 345/619

(57) ABSTRACT

A method of assisting the reading of alphanumeric characters on a display of a digital device is disclosed, in which the alphanumeric characters are displayed in horizontal rows and/or columns. A user selection of a position in the displayed alphanumeric characters is received and a row or column corresponding to the selected position in the displayed alphanumeric characters is visually emphasised to assist the reading of the alphanumeric characters in the row or column.

### FIELD OF THE INVENTION

The present invention relates to an apparatus and method for assisting the reading of displayed alphanumeric characters.

### BACKGROUND TO THE INVENTION

Traditionally, when reading text on paper, particularly long rows or columns of figures with no guide lines, readers will often resort to using a reading guide such as a ruler to assist in the reading of the text to ensure that the readers position is not lost. With the prevalent use of digital technology printed documents are giving way to digitally displayed documents. Thus readers spend much more time reading text and figures on a display screen of a digital device. Using such a medium the readers still have the basic need to assist them in the reading of the text displayed on the screen. This is particularly the case with the increasing resolution available for computer screens thus enabling far more text to be displayed at once. One solution open to the reader is to resort to the retrograde use of a ruler or similar straight edged device to track the lines or columns of the text as required by the user.

The inventor of the present invention has identified a need for an improved method of assisting a reader of alphanumeric characters on a display.

### SUMMARY OF THE INVENTION

The present invention provides a method and apparatus which overcomes the deficiency in the prior art by enabling a user of a digital device, on which alphanumeric characters are displayed in rows and/or columns, to select a position in the displayed alphanumeric characters whereby a row or column corresponding to the selected position in the displayed alphanumeric characters is visually emphasised to assist the reading of the alphanumeric characters in the row or column.

The present invention thus provides what is often termed a software feature which can be included in software performing the display and processing of the alphanumeric characters, or it can be provided as a separate software application which can interface with one or any number of alphanumeric character processing and display applications, such as spreadsheet applications and text processing applications, including word processing applications, email applications, and HTML editor applications for example.

In one embodiment, the row or column can be visually emphasised by displaying an opaque bar adjacent to the row or column. In this embodiment the bar can be displayed between the row or column and an adjacent row or column.

In another embodiment, the row or column is visually emphasised by highlighting the row or column.

In another embodiment, the row or column is visually emphasised by magnifying the row or column.

In one embodiment, a user can enter a request to move the visual emphasis to another row or column respectively when the user has finished reading the alphanumeric characters in the row or column. Conveniently this can be carried out by a drag operation using a pointing device.

In one embodiment, the software features is enabled by initially receiving a user selection to enable the visually emphasis of a row or column to assist reading.

In one embodiment where the alphanumeric characters can be processed, for example by insertion, deletion or movement, the visual emphasis stays with the row or column of alphanumeric characters if the row or column is moved in the display.

In one embodiment, user input comments are input by a user for association with the row or column, and the input comments are displayed when the row or column is visibly emphasised. This enables a user to add useful comments which are associated with the row and can appear whenever the row or column is selected for visible emphasis. Thus the comments entered are associated with the alphanumeric characters, and in one embodiment will stay associated even if the alphanumeric characters move. In one specific embodiment, the user input comments are displayed in a bar used to visually emphasise the row or column. In another specific embodiment, a user initially selects to enable the visually emphasis of a row or column to assist reading, and to enable the input of comments.

In one embodiment, the alphanumeric characters are displayed in a spreadsheet and the row comprises a row of cells and the column comprises a column of cells.

In one embodiment, the alphanumeric characters are displayed in a text processing application and the row comprises a line of text and the column comprises a column of text.

The present invention can be implemented in software on a programmable digital apparatus. It can also be implemented solely in hardware or in a mix or hardware and software.

Since the present invention can be implemented in software, the present invention can be embodied as computer readable code provided to a programmable apparatus on any suitable carrier medium. Such a carrier medium can comprise a transient medium i.e. a signal such as an electrical signal, an electronic signal, optical signal, an acoustic signal, a magnetic signal, or an electromagnetic signal e.g. a microwave or RF signal Alternatively the carrier medium can comprise a storage medium such as a floppy disk, CD ROM, had disk drive, magnetic tape device, or a solid state memory device.

### BRIEF DESCRIPTION OF THE DRAWINGS

Embodiments of the present invention will now be described with reference to the accompanying drawings, in which:

FIG. 1 is a schematic diagram of a digital apparatus in accordance with one embodiment of the present invention;

FIG. 2 is a schematic diagram of a digital apparatus in accordance with another embodiment of the present invention;

FIG. 3 is a schematic diagram of a display in accordance with one embodiment of the present invention;

FIG. 4 is a schematic diagram of a display in accordance with another embodiment of the present invention;

FIG. 5 is a schematic diagram of a display in accordance with a further embodiment of the present invention; and

FIG. 6 is a schematic diagram of a display in accordance with a further embodiment of the present invention.

### DESCRIPTION OF SPECIFIC EMBODIMENTS

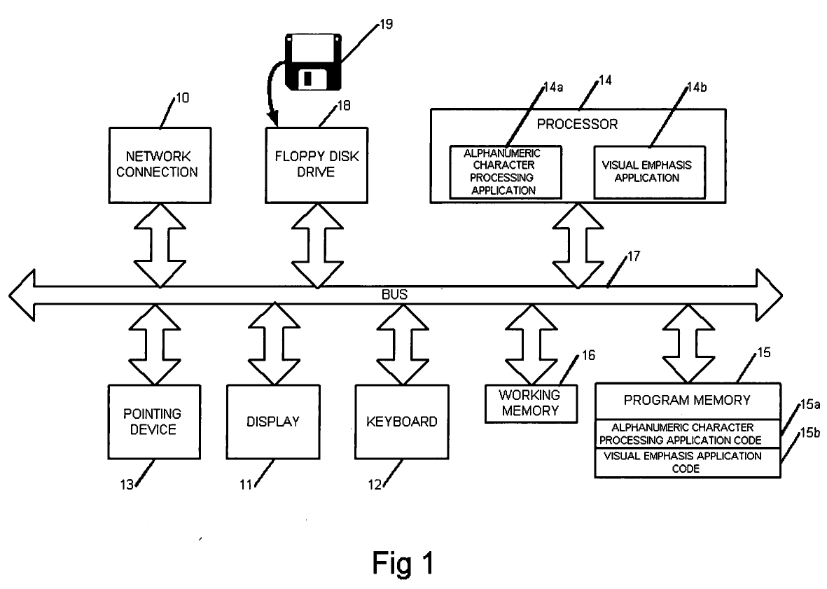

FIG. 1 illustrates the apparatus in accordance with a first embodiment of the present invention which comprises software loaded onto a personal computer. The computer comprises a keyboard 12, a display 11, and a pointing device 13 such as a mouse or track pad to provide a user interface to allow a user to input user selections and comments as will be described in more detail hereinafter. The computer also has volatile memory which is divided into working memory 16 for use during operation and program memory 15 to store program code to be executed. The computer includes a processor 14 for loading and implementing the program code stored in the program memory 15. In this embodiment the program memory stores alphanumeric character processing application code 15a such as a spreadsheet application, or a text processing application including a word processing application, an email application, and an HTML editor application, for execution by the processor 14 to implement an alphanumeric character processing application 14a. Also the program memory 15 stores visual emphasis application code 15b for execution by the processor 14 to implement a visual emphasis application 14b interfaced with the alphanumeric character processing application 14a.

The computer is also provided with a network connection 10 to enable the downloading of program code into the program memory 15. The computer is also provided with a floppy disk drive 18 for receiving floppy disks 19 carrying program code for loading into the program memory 15. A bus 17 interconnects all of the components of the computer.

Thus in this embodiment of the present invention the functionality is provided by a general purpose computer programmed with a prior art alphanumeric character processing application and a visual emphasis application acting as an ‘add-on’ to enhance the functionality of the prior art alphanumeric character processing application to enable a user to select a row or column of alphanumeric characters at a position on the display in order to visually enhance the row or column to assist in the reading of the alphanumeric characters in the row or column.

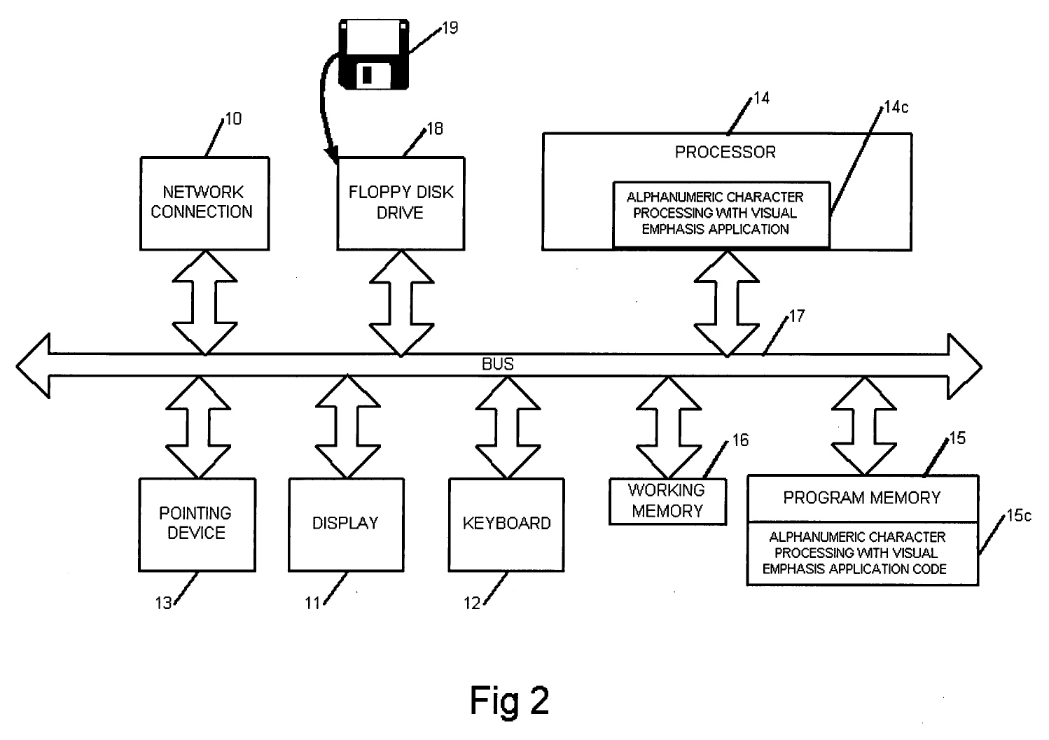

FIG. 2 illustrates a second embodiment of the present invention. In this embodiment like reference numerals are used for like components to the first embodiment of the present invention. This embodiment differs from the first embodiment in that the program memory 15 stores only one set of program code: alphanumeric processing with visual emphasis application code 15c. This is loadable and executable by the processor 14 to implement an alphanumeric processing with visual emphasis application 14c. This application is capable of carrying out processing and display of the alphanumeric characters as well as visually enhancing a selected row or column. Thus the application comprises a combination of the two applications in the first embodiment.

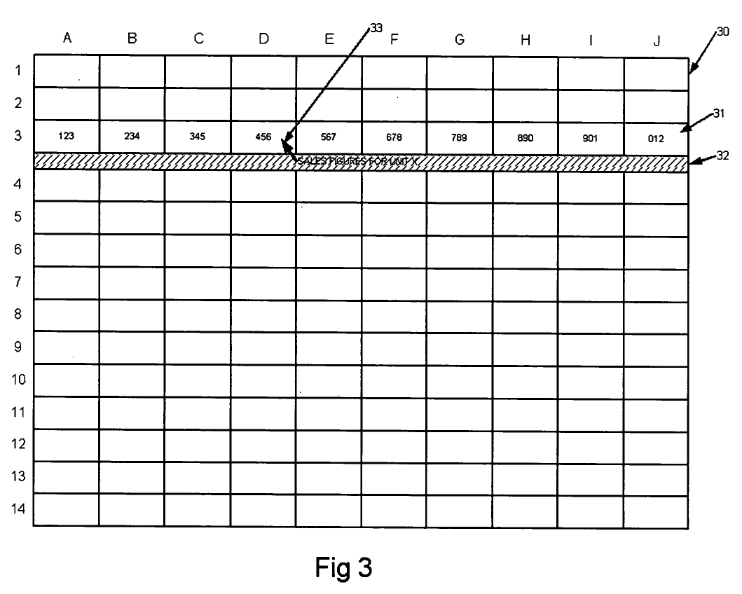

FIGS. 3 to 6 illustrate displays according to three different embodiments of the present invention.

The embodiment of FIG. 3 shows the enhancement of a spreadsheet display 30. A spreadsheet such as Microsoft Excel (Trade Mark), as is well known in the art, is formed of cells indexed by letters along one axis and numbers along the other axis. The cells displayed contain alphanumeric characters which can comprise letters forming words, numbers, or text comprising equations for performing operations on the content of cells, or a combination of these. The cells form numbered rows and labelled columns. In this example the display 30 is quite clear to read since there are only 14 rows and 10 columns. However, in large spreadsheets displayed on a high resolution display, the identification of cells belonging to the same row and/or column can be difficult. It is this problem that this embodiment of the present invention addresses.

A user can use the pointing device 13 to move a cursor 33 to a position over a row or column 31. A user can then select to visually enhance the row or column. This can be done by any well know graphical use interface manner. For example a user could ‘right click’ on the row or column to display a menu that includes the option to visually enhance the row or column. The menu can include the option to visually enhance a row or a column. It can also give the use the option to select to add a comment to the enhancement.

As can be seen in FIG. 3, the visual enhancement of the selected row 31 is by way of a bar 32 displayed underneath the selected row 31. Thus this acts like a ruler positioned by a user under the line that they are reading. In this example the user has added the comment ‘SALES FIGURES FOR UNIT X’. This can provide an additional bookmark feature to visually enhance the reading of the row. In this embodiment, a user can move the bar 32 as they read the text. For example the bar 32 can be ‘dragged’ using the know drag operation. As the bar is moved the comments will change and will reflect the comments associated with the row or column that the bar is visually highlighting.

In this embodiment the positioning of the bar 32 and the appearance of the bar 32 can be user configurable. One method of configuration is to provide a menu option which is available before a user adds a bar 32 to the screen 30. This can allow a user to select to enable the visual enhancement feature e.g. to activate the menu option when a right click operation is made over a row or column, and to enable the addition of comments to a bar 32. Also the user can select the position of the bar 32 e.g. under or over a selected row or to the right or left of a selected column. Another method of configuration is to provide the menu options when a user selects to add a bar 32 e.g. when a user right clicks on a selected row or column.

Although not shown in FIG. 3, a user can select to add more than one bar 32 if required. Also if a user were to add more rows above the selected row 31, the bar 32 will move with the selected row. If a column is added, the extra cell of the column is incorporated in the selected row and the bar 32 extends to be associated with the new cell in the selected row.

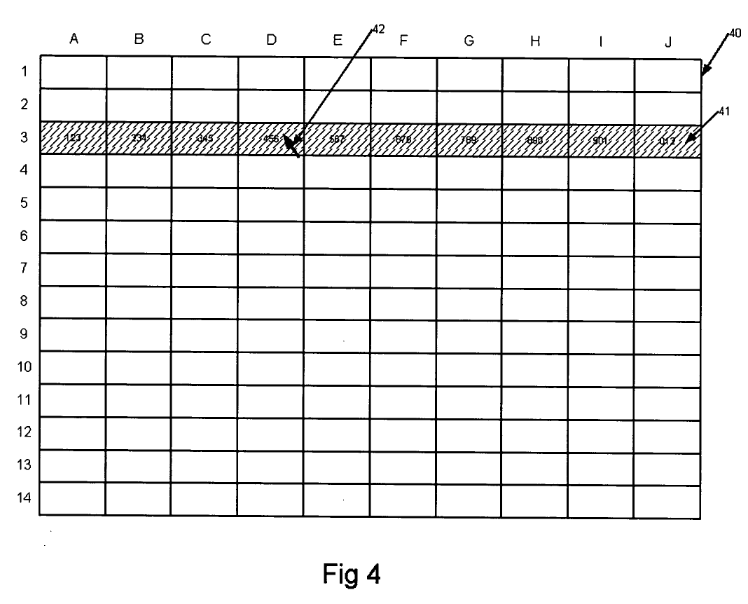

FIG. 4 shows an alternative embodiment in which the method of visual enhancement of a row 41 in a spreadsheet display 40 selected using a curser 42 is by way of highlighting of the row.

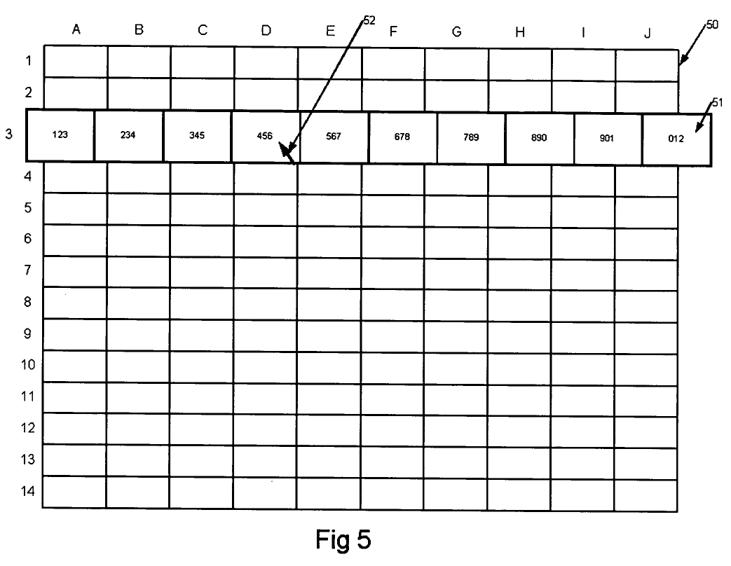

FIG. 5 shows another embodiment of the present invention in which the method of visual enhancement of a row 51 in a spreadsheet display 50 selected using a curser 52 is by way of magnification of the row 51.

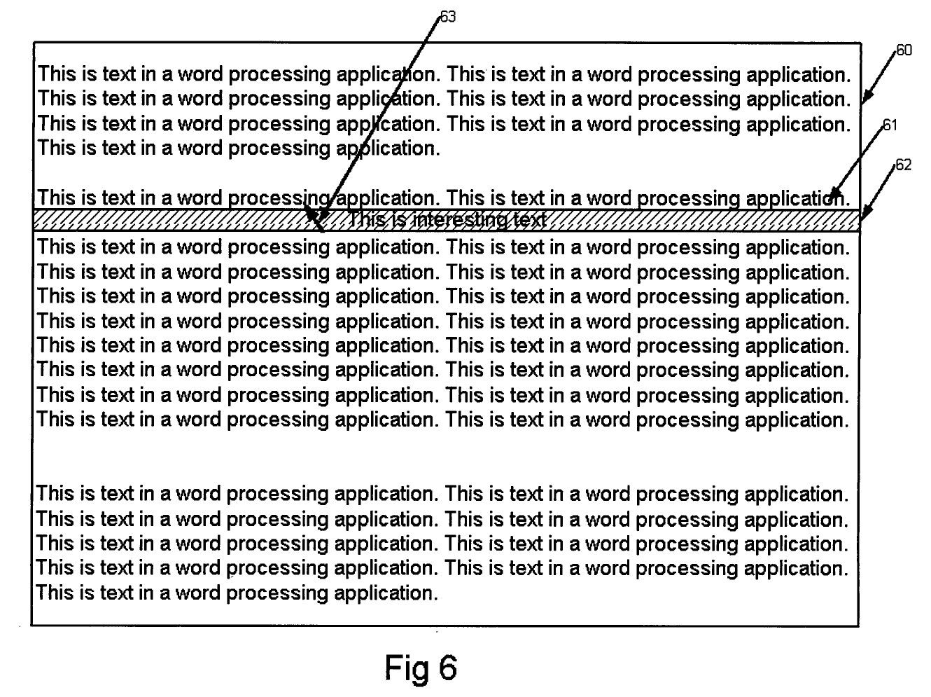

FIG. 6 shows a further embodiment of the present invention applied to a word processing application. Text is displayed in a window 60. A user can use a curser 63 to select a line of text 61 to be visually enhanced. In this embodiment the visual enhancement takes the form of a bar 62 displayed underneath the line of text 61. In this embodiment a user has added the comment ‘This is interesting text’.

In the embodiments of FIGS. 4 and 5, there are no comments displayed in the visually enhanced area. This is because in these embodiments the display of comments in such a manner would detract from the enhanced visibility of the selected row or column. In one embodiment of the present invention it is possible for the user to select to add comments not in the visually enhanced area but anywhere else, such as in a separate window or screen area. The comments can be displayed all the time the visual enhancement is present or alternatively the comments in the visually enhanced area or separately can only be displayed when a user selects to do so.

Although the present invention has been described with reference to specific embodiments, it will be apparent to a skilled person in the art that modifications lie within the spirit and scope of the present invention.

1. A method of assisting the reading of alphanumeric characters on a display of a digital device, wherein the alphanumeric characters are displayed in horizontal rows and/or columns, the method comprising:
receiving a user selection of a position in the displayed alphanumeric characters; and
visually emphasising a row or column corresponding to the selected position in the displayed alphanumeric characters to assist the reading of the alphanumeric characters in said row or column.

2. A method according to claim 1, wherein said row or column is visually emphasised by displaying an opaque bar adjacent to said row or column.

3. A method according to claim 2, wherein said bar is displayed between said row or column and an adjacent row or column.

4. A method according to claim 1, wherein said row or column is visually emphasised by highlighting said row or column.

5. A method according to claim 1, wherein said row or column is visually emphasised by magnifying said row or column.

6. A method according to claim 1, including receiving a user request to move the visual emphasis to another row or column respectively when the user has finished reading the alphanumeric characters in said row or column.

7. A method according to claim 6, wherein said user request comprises a drag operation using a pointing device.

8. A method according to claim 1, including initially receiving a user selection to enable the visually emphasis of a row or column to assist reading.

9. A method according to claim 1, wherein said visual emphasis stays with the row or column of alphanumeric characters if the row or column is moved in the display.

10. A method according to claim 1, including receiving user input comments for association with the row or column, and displaying the input comments on the display when the row or column is visibly emphasised.

11. A method according to claim 2, including receiving user input comments for association with the row or column, and displaying the input comments in said bar.

12. A method according to claim 10, including initially receiving a user selection to enable the visually emphasis of a row or column to assist reading, and receiving a user selection to enable the input of comments.

13. A method according to claim 1, wherein the alphanumeric characters are displayed in a spreadsheet and said row comprises a row of cells and said column comprises a column of cells.

14. A method according to claim 1, wherein the alphanumeric characters are displayed in a text processing application and said row comprises a line of text and said column comprises a column of text.

15. Apparatus for assisting the reading of alphanumeric characters on a display of a digital device, wherein the alphanumeric characters are displayed in horizontal rows and/or columns, the apparatus comprising:
user input means for receiving a user selection of a position in the displayed alphanumeric characters; and
display control means for controlling the display to visually emphasise a row or column corresponding to the selected position in the displayed alphanumeric characters to assist the reading of the alphanumeric characters in said row or column.

16. Apparatus according to claim 15, wherein said display control means is adapted to control said display to visually emphasise said row or column by displaying an opaque bar adjacent to said row or column.

17. Apparatus according to claim 16, wherein said display control means is adapted to control said display to display said bar between said row or column and an adjacent row or column.

18. Apparatus according to claim 15, wherein said display control means is adapted to control said display to visually emphasise said row or column by highlighting said row or column.

19. Apparatus according to claim 15, wherein said display control means is adapted to control said display to visually emphasise said row or column by magnifying said row or column.

20. Apparatus according to claim 15, wherein said user input means is adapted to receive a user request to move the visual emphasis to another row or column respectively when the user has finished reading the alphanumeric characters in said row or column.

21. Apparatus according to claim 20, wherein said user input means comprises a pointing device and said user request comprises a drag operation using said pointing device.

22. Apparatus according to claim 15, wherein said user input means is adapted to initially receive a user selection to enable the visually emphasis of a row or column to assist reading.

23. Apparatus according to claim 15, wherein said display control means is adapted to cause said visual emphasis to stay with the row or column of alphanumeric characters if the row or column is moved in the display.

24. Apparatus according to claim 15, wherein said user input means is adapted to receive user input comments for association with the row or column, and said display control means is adapted to control said display to display the input comments when the row or column is visibly emphasised.

25. Apparatus according to claim 16, wherein said user input means is adapted to receive user input comments for association with the row or column, and said display control means is adapted to control said display to display the input comments in said bar.

26. Apparatus according to claim 24, wherein said user input means is adapted to initially receive a user selection to enable the visually emphasis of a row or column to assist reading, and to receive a user selection to enable the input of comments.

27. Apparatus according to claim 15, wherein the alphanumeric characters are displayed in a spreadsheet and said row comprises a row of cells and said column comprises a column of cells.

28. Apparatus according to claim 15, wherein the alphanumeric characters are displayed in a text processing application and said row comprises a line of text and said column comprises a column of text.

29. A digital processing apparatus for assisting the reading of alphanumeric characters displayed in horizontal rows and/or columns, the apparatus comprising:
a data memory storing data representing the alphanumeric characters;
a display for displaying the alphanumeric characters in rows and/or columns;
program memory storing program instructions for execution by a processor; and
a processor for executing the program instructions stored in said program memory to operate on the data representing the alphanumeric characters stored in said data memory;
wherein said program instructions comprise instructions for controlling said processor to carry out the method of any one of claims 1 to 14.

30. A carrier medium carrying processor implementable instructions for execution by a processor in a digital apparatus to carry out the method of any one of claims 1 to 14.
